(19) United States
(12) Patent Application Publication
(10) Pub. No.: US 2025/0319896 A1
(43) Pub. Date: Oct. 16, 2025

(54) DRIVING ASSISTANCE DEVICE AND DRIVING ASSISTANCE METHOD

(71) Applicants: TOYOTA JIDOSHA KABUSHIKI KAISHA, Aichi-ken (JP); DENSO CORPORATION, Aichi-pref (JP)

(72) Inventors: Takaya YAMASHITA, Nagoya-shi (JP); Hiroki SHIMAZU, Nisshin-shi (JP); Yuki HATSUDE, Toyota-shi (JP); Atsushi KATAOKA, Toyota-shi (JP)

(21) Appl. No.: 19/068,012

(22) Filed: Mar. 3, 2025

(30) Foreign Application Priority Data
Apr. 16, 2024 (JP) 2024-066256

(51) Int. Cl. B60W 50/14; H04W 4/46; H04W 4/80

(52) U.S. Cl. CPC B60W 50/14; H04W 4/46; H04W 4/80; B60W 2050/143; B60W 2050/146; B60W 2420/403; B60W 2420/408; B60W 2420/54; B60W 2552/50; B60W 2554/20; B60W 2554/4041; B60W 2556/65

(57) ABSTRACT

A driving assistance device for a vehicle is configured to: give notice to a driver when a moving object existing around the vehicle exists in the scope of a driving assistance area that is set around the vehicle; restrict the scope of the driving assistance area to an area from the vehicle to a restraining object when the restraining object exists on a side of the vehicle, the restraining object restraining the moving object from entering a travel lane in which the vehicle travels; and lift the restricting of the scope of the driving assistance area when it is determined that the restraining object does not exist ahead of the vehicle.

### CROSS-REFERENCE TO RELATED APPLICATION

This application claims priority to Japanese Patent Application No. 2024-066256 filed on Apr. 16, 2024, incorporated herein by reference in its entirety.

### BACKGROUND

### 1. Technical Field

The disclosure relates to a driving assistance device and a driving assistance method.

### 2. Description of Related Art

As a conventional surroundings monitoring device that gives notice to a driver when a moving object is detected in an alert area behind and on a side of the subject vehicle, WO 2023162559 discloses one that refrains from giving notice to a driver when there exists, on a side of the subject vehicle, a restraining object that restrains another object from entering the own lane.

### SUMMARY

There are some cases where a restraining object, such as a guard rail, exists up to immediately before an area (hereinafter, referred to as “lane changeable area”) where a lane change can be made between the own lane and a next lane. In such cases, there is a possibility that a lane change is immediately made in the lane changeable area after the restraining object ceases to exist. Accordingly, starting to give notice to a driver at a point before the lane changeable area is considered as one of effective measures to prevent contact with another vehicle. However, in the case of the conventional surroundings monitoring device, since it is impossible to give notice to the driver before the restraining object ceases to exist, there is a problem that notice cannot be given to the driver at a point before the lane changeable area.

The disclosure has been made, with attention drawn to such a problem, and an object thereof is to make it possible to give notice related to a moving object existing in a driving assistance area around a subject vehicle, to a driver at an appropriate timing.

To solve the problem, a driving assistance device for a vehicle according to an aspect of the disclosure is configured to: give notice to a driver when a moving object existing around the vehicle exists in the scope of a driving assistance area that is set around the vehicle; restrict the scope of the driving assistance area to an area from the vehicle to a restraining object when the restraining object exists on a side of the vehicle, the restraining object restraining the moving object from entering a travel lane in which the vehicle travels; and lift the restricting of the scope of the driving assistance area when it is determined that the restraining object does not exist ahead of the vehicle.

A driving assistance method for a vehicle according to an aspect of the disclosure includes: giving notice to a driver when a moving object existing around the vehicle exists in the scope of a driving assistance area that is set around the vehicle; restricting the scope of the driving assistance area to an area from the vehicle to a restraining object when the restraining object exists on a side of the vehicle, the restraining object restraining the moving object from entering a travel lane in which the vehicle travels; and lifting the restricting of the scope of the driving assistance area when it is determined that the restraining object does not exist ahead of the vehicle.

According to the aspects of the disclosure, since the restricting of the scope of the driving assistance area is lifted when it is determined that the restraining object does not exist ahead of the vehicle, it is possible to give notice related to the moving object existing in the driving assistance area around the subject vehicle to the driver at an appropriate timing even if the restraining object exists.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a driving assistance device according to an embodiment of the disclosure;

FIG. 2 shows an example of a driving assistance area that is set beforehand around a subject vehicle;

FIG. 3 shows an example of a scene in which a restraining object that restrains another object from entering the own lane exists on a side of the subject vehicle;

FIG. 4 shows another example of a scene in which a restraining object that restrains another object from entering the own lane exists on a side of the subject vehicle; and

FIG. 5 is a flowchart that describes driving assistance control according to the embodiment of the present disclosure.

### DETAILED DESCRIPTION OF EMBODIMENTS

Hereinafter, an embodiment of the disclosure is described in detail with reference to the drawings. Note that in the description below, similar constituent elements are denoted by the same reference signs.

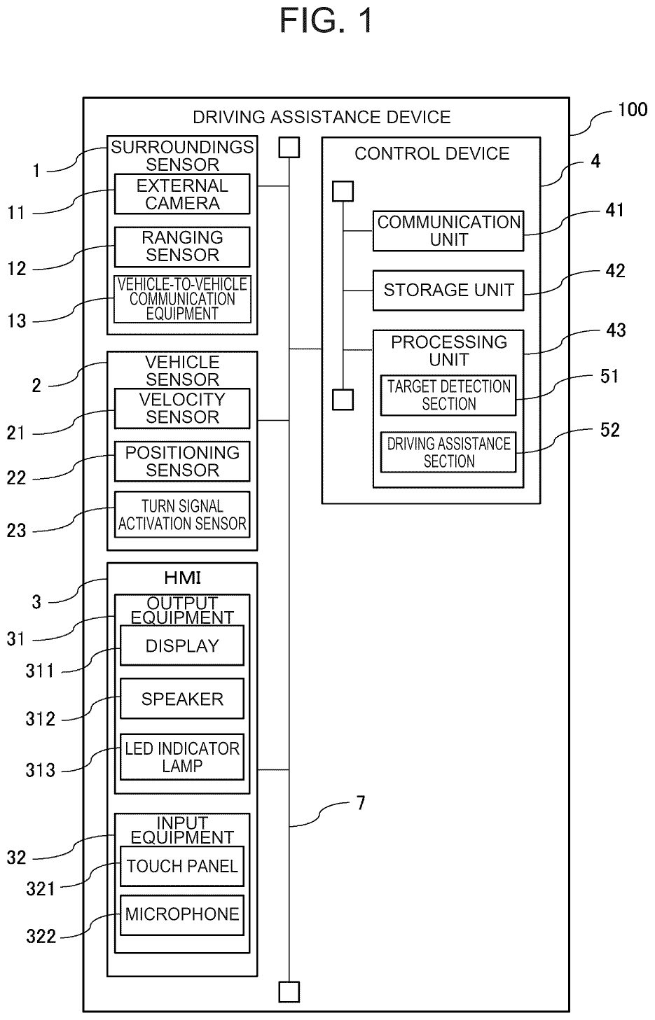

FIG. 1 is a schematic configuration diagram of a driving assistance device 100 according to the embodiment of the disclosure.

The driving assistance device 100 includes a surroundings sensor 1, a vehicle sensor 2, a human machine interface (HMI) 3, and a control device 4. The surroundings sensor 1, the vehicle sensor 2, the HMI 3, and the control device 4 are communicably connected to each other through an in-vehicle network 7 that conforms with a standard, such as a controller area network.

The surroundings sensor 1 is a sensor for generating surroundings data that indicates a situation around a vehicle (hereinafter, referred to as “subject vehicle”) for which driving assistance is performed by the driving assistance device 100. In the embodiment, for the surroundings sensor 1, one or more external cameras 11 for capturing images of surrounding of the subject vehicle, one or more ranging sensors 12 that measure the distances to various targets, such as another vehicle (an automobile, a two-wheel vehicle, or the like), a pedestrian, a building, and a restraining object, that exist around the subject vehicle, and vehicle-to-vehicle communication equipment 13 that can communicate with another vehicle existing around the subject vehicle are included.

The external camera 11 captures images of the surroundings of the subject vehicle at a predetermined frame rate (for example, 10 [Hz] to 40 [Hz]) and generates surroundings images in which the surroundings of the subject vehicle appear. Each time surroundings images are generated, the external camera 11 transmits the generated surroundings images, as surroundings data, to the control device 4.

The ranging sensor 12 applies laser lights, radio waves, ultrasonic waves, or the like to a distance measurement area around the subject vehicle and receives a reflected light of each laser light applied, or a reflected wave of each radio wave or each ultrasonic wave applied. Based on the received reflected lights or reflected waves, the ranging sensor 12 measures the distances to the various targets existing in the distance measurement area. The ranging sensor 12 transmits distance measurement data, as surroundings data, in which the distance to each target and coordinate information on the target are associated, to the control device 4. Examples of the ranging sensor 12 include, for example, light detection and ranging (LiDAR), which applies radar light and measures distance based on the reflected light, and a millimeter-wave radar sensor, which applies radio waves and measures distance based on the reflected waves.

The vehicle-to-vehicle communication equipment 13 performs communication with another vehicle existing around the subject vehicle to transmit and receive vehicle-to-vehicle information. The vehicle-to-vehicle information includes, for example, current position data indicating the current position of a vehicle that is the source of the vehicle-to-vehicle information, velocity data indicating the traveling velocity of the vehicle, and the like. The vehicle-to-vehicle communication equipment 13 transmits, as surroundings data, the current position data and the velocity data on the other vehicle received from the other vehicle to the control device 4.

The vehicle sensor 2 is a sensor for generating vehicle data indicating a situation of the subject vehicle. In the embodiment, for the vehicle sensor 2, a velocity sensor 21 that generates velocity data indicating the traveling velocity of the subject vehicle, a positioning sensor 22 that generates current position data indicating the current position of the subject vehicle, such as a latitude and a longitude, a turn signal activation sensor 23 that generates turn signal activation data indicating an activated state of a turn signal (blinker) of the subject vehicle, and the like are included. However, the vehicle sensor 2 is not limited to the above-mentioned sensors. The vehicle sensor 2 transmits each acquired data, as vehicle data, to the control device 4.

The HMI 3 is a user interface for the subject vehicle and an occupant thereof to exchange information. The HMI 3 includes output equipment 31 for making a notice to the vehicle occupant via a bodily sense (for example, sight, hearing, touch, or the like) of the vehicle occupant, and input equipment 32 for the vehicle occupant to perform an input operation and a response operation. In the embodiment, for the output equipment 31, displays (for example, a meter display, a center display, a head-up display, and the like) 311, a speaker 312, and an LED indicator lamp 313 are included, and for the input equipment 32, a touch panel 321 and a microphone 322 are included.

The HMI 3 displays, on the displays 311, information (for example, character information or image information) according to a display signal received from the control device 4 and also outputs, from the speaker 312, sound according to a sound signal. The HMI 3 transmits, to the control device 4, data (hereinafter, referred to as “occupant-input data”) that is input through the panel or input through voice by the vehicle occupant via the input equipment 32.

The HMI 3 may be mounted on the subject vehicle beforehand, or may be a terminal, such as a smartphone, owned by the vehicle occupant. In the latter case, for example, information may be exchanged by the subject vehicle and the terminal of the vehicle occupant performing near-field wireless communication, or information may be exchanged indirectly via an external server (not depicted) by the terminal of the vehicle occupant and the server performing communication.

The control device 4 is an electronic control unit (ECU) including a communication unit 41, a storage unit 42, and a processing unit 43.

The communication unit 41 includes interface circuitry for connecting the control device 4 to the in-vehicle network 7. The communication unit 41 supplies various data received from each sensor 1, 2, the HMI 3, and the like to the processing unit 43. The communication unit 41 outputs various signals output from the processing unit 43 to the 25 HMI 3 and the like.

The storage unit 42 includes a storage medium, such as a hard disk drive (HDD), a solid state drive (SSD), or a semiconductor memory, and stores various computer programs, data, and the like that are used in processes by the processing unit 43.

The processing unit 43 includes one or more central processing units (CPU) and peripheral circuitry thereof and executes the various computer programs stored in the storage unit 42. The processing unit 43 is, for example, a processor. The processing unit 43 may further include other operation circuitry, such as a logic operation unit, an arithmetic operation unit, or a graphics processing unit. The processing unit 43 functions as a target detection section 51 and a driving assistance section 52 by executing processes according to the computer programs, and operates as the functional sections (modules) each implementing a predetermined function. In the description below, when processes are described by using the individual functional sections 51, 52 for the subjects of sentences, such description indicates that the processing unit 43 is executing the programs that implement the individual functional sections 51, 52.

Hereinafter, details of the specific processes that are executed by the control device 4 are described. In other words, details of the individual functional sections 51, 52 that are implemented by the processing unit 43 executing the processes according to the programs are described.

The target detection section 51 detects a target existing around the subject vehicle, based on the surroundings data received from the surroundings sensor 1. In the embodiment, the target detection section 51 detects a moving object, such as another vehicle, that exists around the subject vehicle, and a restraining object that exists on a side of the subject vehicle and restrains another object from entering the own lane. The restraining object is, for example, a guard rail, a signpost, a wire rope, curbstones, a wall, or the like.

For example, by sequentially inputting surroundings images received from the external camera 11 into a discriminator, the target detection section 51 detects, in each surroundings image, an area in which targets, such as another vehicle, a pedestrian, a building, and a restraining object, appear, and the type of each target appearing in the area. The discriminator can be, for example, a convolutional neural network (CNN) including a plurality of convolutional layers that are connected in series from an input side to an output side. The target detection section 51 estimates the distance from the external camera 11 to each target by using a standard size of the target, which is stored in the storage unit 42 for each target type, and a size of the target that is detected in each surroundings image. The target detection section 51 also calculates the position and the velocity of each target by tracking the target detected in the surroundings images in chronological order. Note that the target detection section 51 can also calculate the distance to each detected target, based on the distance measurement data from the ranging sensor 12.

Moreover, the target detection section 51 calculates the relative position of the other vehicle around the subject vehicle, based on the vehicle-to-vehicle information (current position data and the like on the other vehicle) received by the vehicle-to-vehicle communication equipment. Generally, when the restraining object is a higher wall than the height of the other vehicle, the other vehicle over the restraining object cannot be recognized by the external camera 11 or the ranging sensor 12. However, by acquiring the current position data on the other vehicle around by using the vehicle-to-vehicle information as in the embodiment, the relative position of the other vehicle can be calculated even when the restraining object is a higher wall than the height of the other vehicle.

Note that a method of detecting a target is not limited to the methods as described above, and detection may be performed through any of various commonly known schemes.

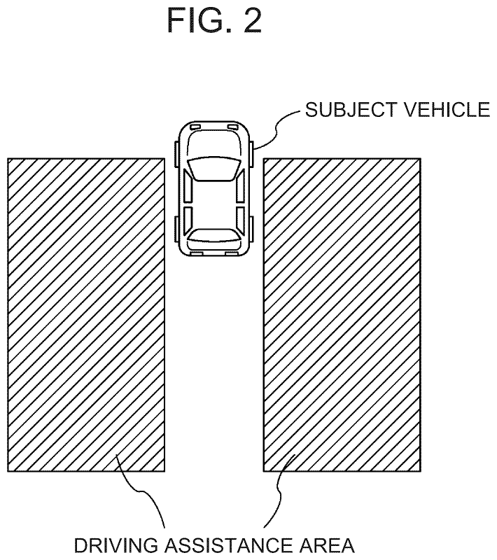

For driving assistance to the driver, when the moving object, such as the other vehicle, recognized by the target detection section 51 exists in the driving assistance area (see FIG. 2) that is set beforehand around the subject vehicle, the driving assistance section 52 issues, via the HMI 3, an alert that is an example of notice informing the driver that the moving object exists in the driving assistance area. A way of issuing an alert is not particularly limited. For example, an alert by causing an LED indicator lamp 313 to light up or blink, an alert via a message, an alert via sound, a sensory alert by causing a steering wheel to vibrate or the like can be issued.

Hereinafter, the driving assistance by the driving assistance section 52 is described in further detail with reference to FIGS. 2 to 5.

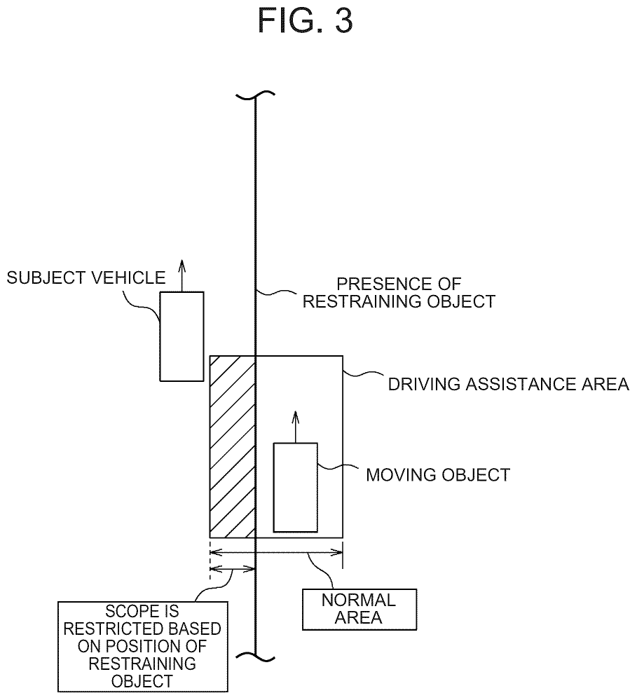

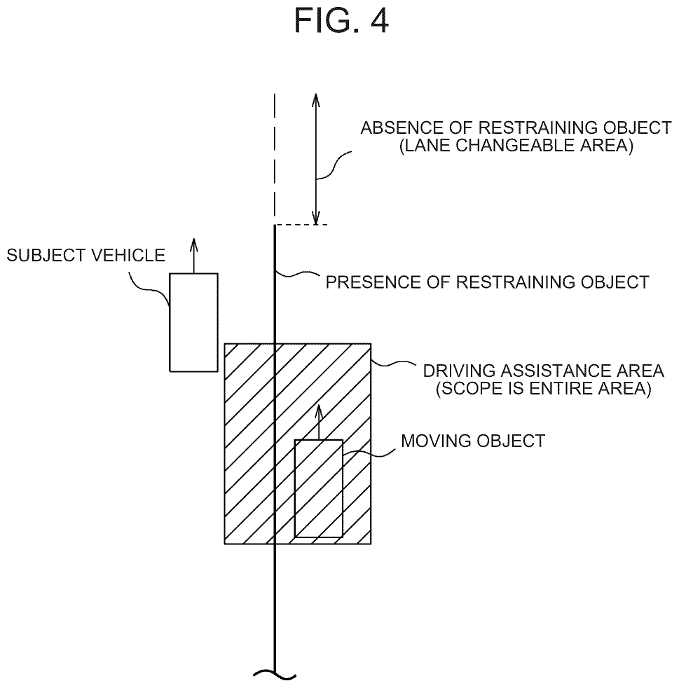

FIG. 2 shows an example of the driving assistance areas that are set beforehand around the subject vehicle. FIGS. 3 and 4 show examples, respectively, of a scene in which a restraining object that restrains another object from entering the own lane exists on a side of the subject vehicle.

As shown in FIG. 2, the driving assistance areas are areas on the right and left sides of and behind the subject vehicle which are difficult for the driver to directly see.

Here, there are some cases where a restraining object that restrains another object from entering the own lane exists on a side of the subject vehicle, as shown in FIG. 3. In such a case, if a moving object exists over the restraining object and even if the moving object exists in the driving assistance area for the subject vehicle as shown in FIG. 3, the probability of contact with the moving object is low because a lane change is restrained by the restraining object. If an alert informing the driver about the existence of such a moving object that has a low probability of contact with the subject vehicle is issued as driving assistance to the driver, there is a possibility that the driving assistance is found annoying, depending on the driver.

Accordingly, in the embodiment, when a restraining object exists on a side of the subject vehicle, the scope of the driving assistance area is restricted to a subject vehicle-side area from the restraining object, as shown as a diagonally shaded area in FIG. 3. The scope of the driving assistance area is, in other words, a target area, in the driving assistance area, where driving assistance is performed. Accordingly, the entire area of the driving assistance area is the scope thereof, in normal times.

In contrast, there are many cases where ahead of the subject vehicle is a lane changeable area, in which a lane change can be made between the own lane and a next lane, and a restraining object exists up to immediately before the lane changeable area, as shown in FIG. 4. In such a case, there is a possibility that after the restraining object ceases to exist, a lane change is immediately made in the lane changeable area.

Accordingly, when there is a lane changeable area ahead of the subject vehicle, one of conceivable effective measures to prevent contact with a moving object in the lane changeable area is to issue an alert informing the driver about the existence of the moving object at a point some time or some distance before the lane changeable area, even if a restraining object exists on a side of the subject vehicle, when the moving object exists over the restraining object and the moving object exists in the driving assistance area for the subject vehicle.

Accordingly, in the embodiment, even if a restraining object exists on a side of the subject vehicle, restriction of the scope of the driving assistance area is not performed when it is determined that the restraining object on the side of the subject vehicle does not exist ahead of the subject vehicle. In other words, the entire area of the driving assistance area is set as the scope thereof, without restricting the scope of the driving assistance area to the subject vehicle-side area from the restraining object.

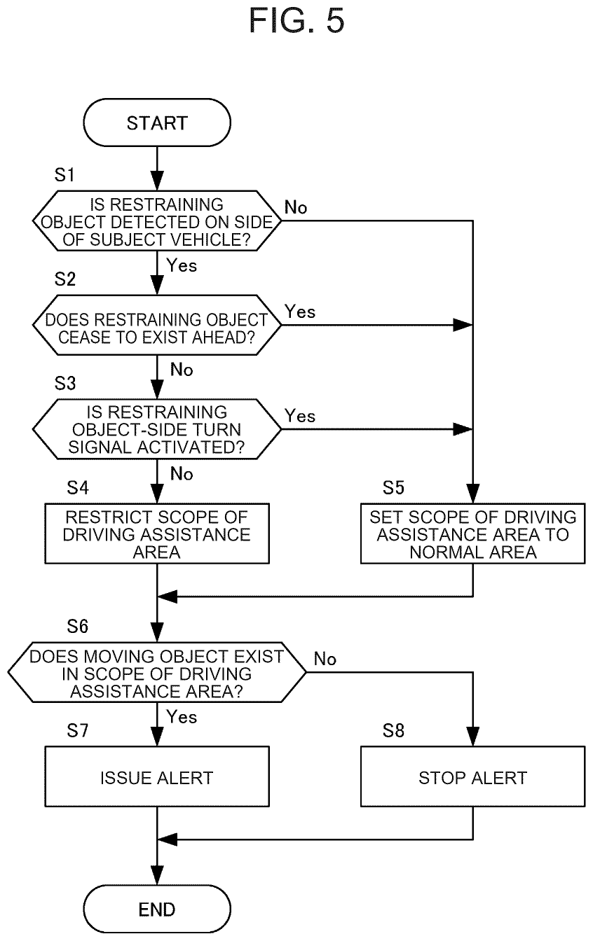

FIG. 5 is a flowchart that describes driving assistance control according to the embodiment, which is performed by the driving assistance section 52, hence by the control device 4. The control device 4 executes the routine in a predetermined operation period ΔT repeatedly.

In step S1, the control device 4 determines whether or not a first restraining object or a second restraining object is detected as a restraining object on a side of the subject vehicle. The first restraining object is, among restraining objects that restrain another object from entering the own lane, a restraining object over which a moving object can be detected by the surroundings sensor 1. The first restraining object is, for example, a lower wall than the heights of vehicles, curbstones, a guard rail, a signpost, a wire rope, or the like. The second restraining object is, among the restraining objects that restrain another object from entering the own lane, a restraining object over which a moving object cannot be detected by the surroundings sensor 1. The second restraining object is, for example, a higher wall than the heights of vehicles.

When the first restraining object or the second restraining object is detected on a side of the subject vehicle, the control device 4 moves to a process in step S2. When neither the first restraining object nor the second restraining object is detected on a side of the subject vehicle, the control device 4 moves to a process in step S5.

In step S2, the control device 4 determines whether the restraining object (first restraining object or second restraining object) on the side of the subject vehicle ceases to exist after a predetermined time period or after a predetermined distance is traveled. A method for the determination is not particularly limited, and for example, the determination can be performed based on an image of a view in front of the subject vehicle captured by the external camera 11, map information, velocity data on the subject vehicle, current position data on the subject vehicle, or the like. When the restraining object on the side of the subject vehicle ceases to exist after the predetermined time period or after the predetermined distance is traveled, the control device 4 moves to the process in step S5. When it is determined that the restraining object on the side of the subject vehicle exists also after the predetermined time period or after the predetermined distance is traveled, or when it is unclear whether the restraining object exists on the side of the subject vehicle after the predetermined time period or after the predetermined distance is traveled, the control device 4 moves to a process in step S3.

In step S3, the control device 4 determines, for example based on the turn signal activation data, whether a turn signal (blinker) on the side on which the restraining object exists is activated. When the turn signal on the side on which the restraining object exists is activated, the control device 4 moves to the process in step S5 even when it is determined in step S2 that the restraining object exists on the side of the subject vehicle also after the predetermined time period or after the predetermined distance is traveled, because it is highly probable that a lane change will be made in the near future, and there is a strong possibility that the determination may have been erroneous. When the turn signal on the side on which the restraining object exists is not activated, the control device 4 moves to a process in step S4.

In step S4, the control device 4 restricts the scope of the driving assistance area to the subject vehicle-side area from the restraining object.

In step S5, the control device 4 sets the scope of the driving assistance area to a normal area. In other words, the entire area of the driving assistance area is set as the scope thereof.

In step S6, the control device 4 determines whether or not a moving object exists in the scope of the driving assistance area. For example, when the restraining object is the first restraining object, the determination can be performed by calculating the position of the moving object, based on surroundings images or the distance measurement data. When the restraining object is the second restraining object, since a moving object over the restraining object is hidden by the restraining object as described above, the position of the moving object cannot be calculated based on surroundings images or the distance measurement data. Accordingly, in the embodiment, when the restraining object is the second restraining object, the position of the moving object is calculated based on the vehicle-to-vehicle information. When a moving object exists in the scope of the driving assistance area, the control device 4 moves to a process in step S7. When a moving object does not exist in the scope of the driving assistance area, the control device 4 moves to a process in step S8.

In step S7, the control device 4 issues, via the HMI 3, an alert informing the driver that another vehicle exists in the driving assistance area.

In step S8, the control device 4 stops an alert informing the driver that another vehicle exists in the driving assistance area.

The driving assistance device 100 for a vehicle according to the embodiment described above is configured to: issue an alert to a driver when a moving object existing around the subject vehicle exists in the scope of the driving assistance area that is set around the subject vehicle; restrict the scope of the driving assistance area to an area from the subject vehicle to a restraining object when the restraining object exists on a side of the subject vehicle, the restraining object restraining the moving object from entering a travel lane in which the subject vehicle travels; and lift the restricting of the scope of the driving assistance area when it is determined that the restraining object does not exist ahead of the subject vehicle. For example, the driving assistance device 100 for a vehicle according to the embodiment is configured to determine that the restraining object does not exist ahead of the subject vehicle when it is determined that a time period taken to reach a point where the restraining object ceases to exist is equal to or less than a predetermined time period, or that a distance up to the point is equal to or less than a predetermined distance.

Thus, when a restraining object exists on a side of the subject vehicle, since the scope of the driving assistance area is restricted to the area from the subject vehicle to the restraining object, it is possible to prevent notice about the existence of the moving object that has a low probability of contact with the subject vehicle from being given to the driver. When it is determined that the restraining object does not exist ahead of the subject vehicle, since the restricting of the scope of the driving assistance area is lifted, it is possible to start giving notice to the driver about the existence of the moving object at a point before a lane changeable area ahead. Accordingly, it is possible to prevent contact with the moving object in the lane changeable area.

Moreover, when the restraining object exists on the side of the subject vehicle, and when a turn signal on the side on which the restraining object exists is activated, the driving assistance device 100 for a vehicle according to the embodiment is configured to lift the restricting of the scope of the driving assistance area even when it is determined that the restraining object exists ahead of the subject vehicle.

Thus, even if the determination of whether or not the restraining object ceases to exist ahead of the vehicle is erroneous, it is possible to start giving notice to the driver about the existence of the moving object at the point before the lane changeable area ahead.

Further, when the restraining object is the second restraining object (predetermined restraining object), over which a moving object cannot be detected by the external camera 11 (camera) or the ranging sensor 12, the driving assistance device 100 for a vehicle according to the embodiment is configured to determine, based on position information on the moving object around the subject vehicle acquired through vehicle-to-vehicle communication (short-range communication), whether the moving object exists in the scope of the driving assistance area.

Thus, it is possible to detect the moving object over the second restraining object, such as a high wall, due to which the moving object cannot be seen by the driver, and to start giving notice to the driver about the existence of the moving object at the point before the lane changeable area ahead.

Although an embodiment of the disclosure has been described hereinabove, the embodiment only illustrates some of application examples of the disclosure, and is not intended to limit the technical scope of the disclosure to the specific configurations in the embodiment.

For example, in the embodiment, when a restraining object is the second restraining object, the description is given by taking an example in which communication with another vehicle, which is an example of the moving object around the subject vehicle, is performed through vehicle-to-vehicle communication, which is an example of the short-range communication. However, for example, based on current position data on a moving object, such as a pedestrian or a bicycle, acquired through pedestrian-to-vehicle communication, which is an example of the short-range communication, it may be determined whether the moving object exists in the driving assistance area.

Furthermore, for example, in the embodiment, the computer programs to be executed by the control device 4 may be provided in the form of being recorded on a computer-readable portable recording medium, such as a semiconductor memory, a magnetic recording medium, or an optical recording medium.

What is claimed is:

1. A driving assistance device for a vehicle, the driving assistance device configured to:
give notice to a driver when a moving object existing around the vehicle exists in a scope of a driving assistance area that is set around the vehicle;
restrict the scope of the driving assistance area to an area from the vehicle to a restraining object when the restraining object exists on a side of the vehicle, the restraining object restraining the moving object from entering a travel lane in which the vehicle travels; and
lift the restricting of the scope of the driving assistance area when it is determined that the restraining object does not exist ahead of the vehicle.

2. The driving assistance device according to claim 1, wherein when the restraining object exists on the side of the vehicle, and when a turn signal on the side on which the restraining object exists is activated, the driving assistance device is configured to lift the restricting of the scope of the driving assistance area even when it is determined that the restraining object exists ahead of the vehicle.

3. The driving assistance device according to claim 1, wherein when the restraining object is a predetermined restraining object over which the moving object is unable to be detected by a camera or a ranging sensor, the driving assistance device is configured to determine whether the moving object exists in the scope of the driving assistance area, based on position information on the moving object around the vehicle that is acquired through short-range communication.

4. The driving assistance device according to claim 1, wherein when it is determined that a time period taken to reach a point where the restraining object ceases to exist is equal to or less than a predetermined time period, or that a distance to the point is equal to or less than a predetermined distance, the driving assistance device is configured to determine that the restraining object does not exist ahead of the vehicle.

5. A driving assistance method for a vehicle, comprising:
giving notice to a driver when a moving object existing around the vehicle exists in a scope of a driving assistance area that is set around the vehicle;
restricting the scope of the driving assistance area to an area from the vehicle to a restraining object when the restraining object exists on a side of the vehicle, the restraining object restraining the moving object from entering a travel lane in which the vehicle travels; and
lifting the restricting of the scope of the driving assistance area when it is determined that the restraining object does not exist ahead of the vehicle.
